(19) United States
(12) Patent Application Publication
(10) Pub. No.: US 2024/0056119 A1
(43) Pub. Date: Feb. 15, 2024

(54) DEVICE AND METHOD FOR ANTENNA CHANGEOVER ON A RADIO TRANSCEIVER

(71) Applicant: Continental Automotive Technologies GmbH, Hannover (DE)

(72) Inventor: Martin Opitz, Regensburg (DE)

(73) Assignee: Continental Automotive Technologies GmbH, Hannover (DE)

(21) Appl. No.: 18/037,603

(22) PCT Filed: Oct. 18, 2021
(86) PCT No.: PCT/DE2021/200152

§ 371 Date: May 18, 2023

(30) Foreign Application Priority Data
Nov. 18, 2020 (DE) 10 2020 214 523.7

(51) Int. Cl. H04B 1/44

(52) U.S. Cl. CPC H04B 1/44

(57) ABSTRACT

A method and a device for controlling antenna changeover of a radio receiver having at least two antennas, wherein the device is configured to change over the transmission in the form of transmitting and/or receiving signals by a first antenna of the radio transceiver to a transmission of signals by an additional antenna of the radio transceiver, wherein an antenna changeover decision interval is determined, after which a decision on the changeover between the antennas is provided at an antenna changeover decision time in each case, taking into consideration at least the negative count of preceding successive negative changeover decisions.

The patent application relates to a device and a method for antenna switching in the case of a radio transceiver, in particular for Bluetooth.

It is an object of the invention to improve the antenna switching in the case of a radio transceiver, in particular for Bluetooth. The object is achieved in each case by the subjects of the independent patent claims.

The use of a negative count (‘WaterLevel_Count’) and negative count limit value (‘WaterLevel_Threshold’) for previous switchings that did not take place in the decision about an antenna switching can make the following advantages possible:
forcing an antenna switching in the case of a predefined number of successively unsuccessful antenna switching decision events being reached,
optionally avoiding antenna switchings in the case of active/imminent radio events.

### Re the Dependent Claims:

According to one embodiment of the invention, a positive count (‘SwitchSuccess_Count’) and a positive count limit value (‘SwitchSuccess_Threshold’) can also be taken into consideration. One possible advantage thereof is
stopping an antenna switching in the case of a predefined number of successively successful antenna switching decision events being reached.

Further features and advantages of some embodiments of the invention will become apparent from the following description of exemplary embodiments with reference to the drawing, in which:

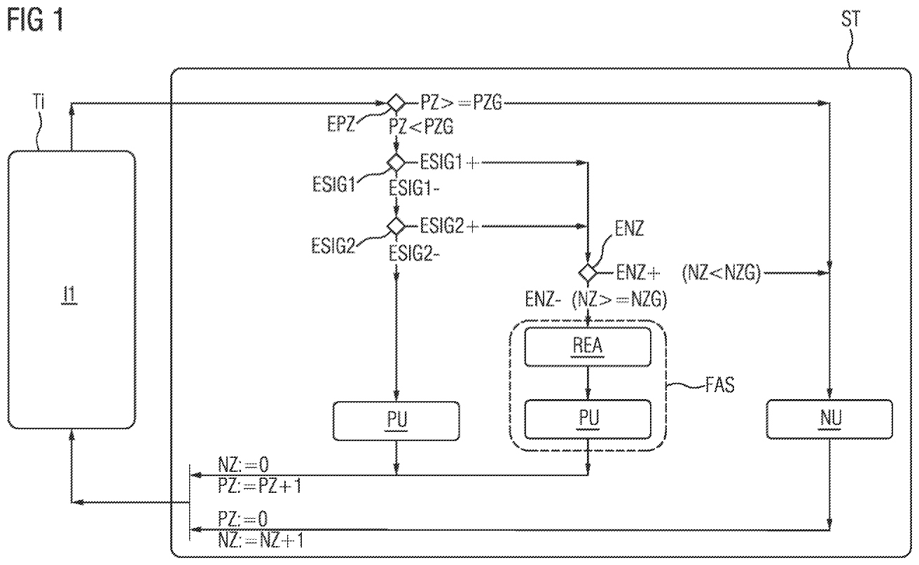

FIG. 1 shows a flow diagram of an antenna switching decision in which the number of previously successive positive and negative switching decisions is also taken into consideration,

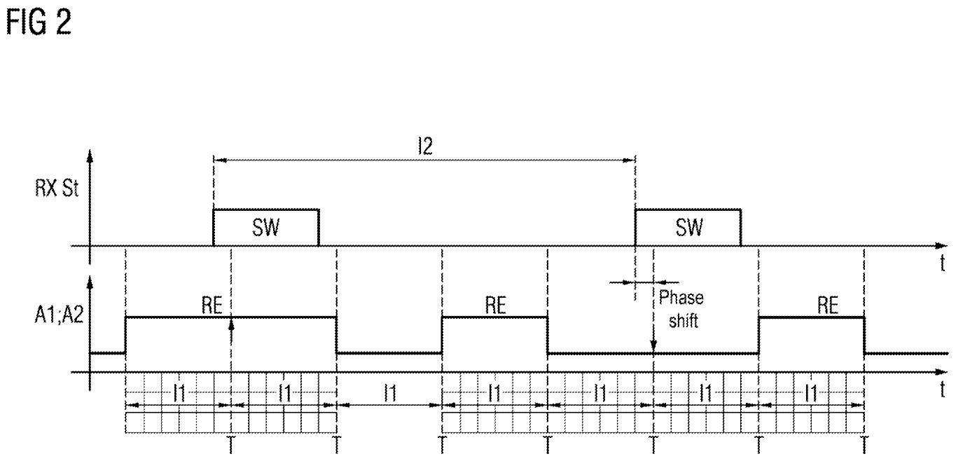

FIG. 2 shows a temporal profile of scan/passive states of a transceiver and, below that, of signal receiving phases of antennas and, below that, antenna switching intervals,

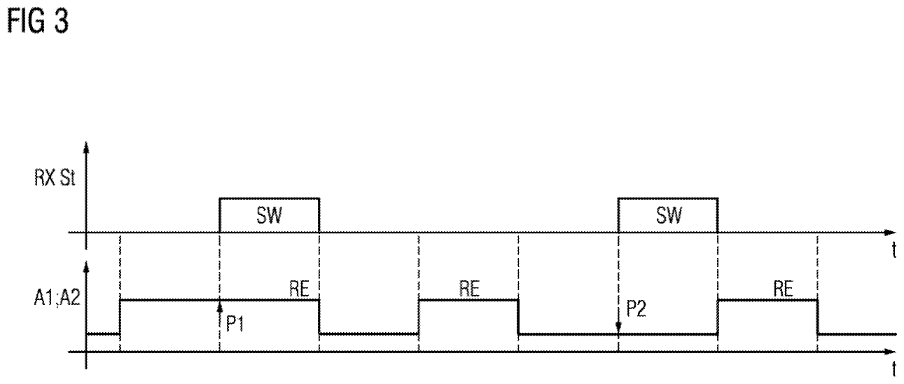

FIG. 3 shows phases of scan events and of antenna switching decision events,

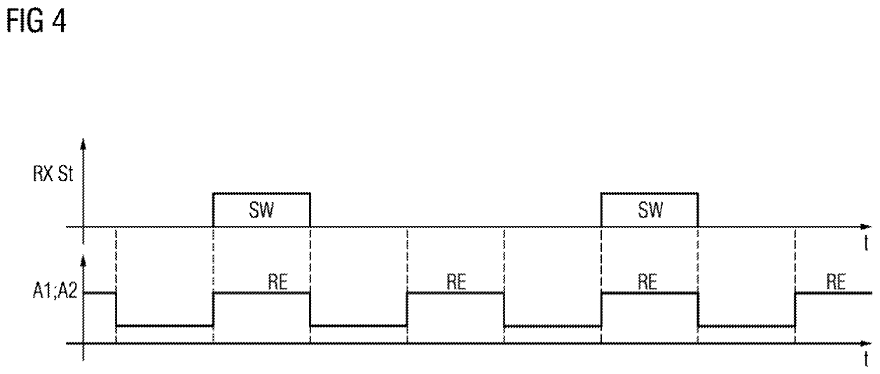

FIG. 4 shows possible synchronization effects that arise when using SW timers (with priority for the timing for carrying out the scanning always being higher than that of an additionally configured timer task for antenna switching),

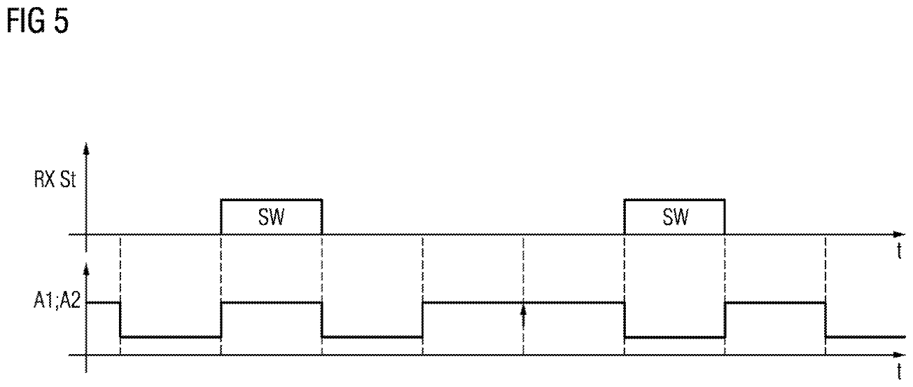

FIG. 5 shows a rejected antenna switching every four antenna switching decision events,

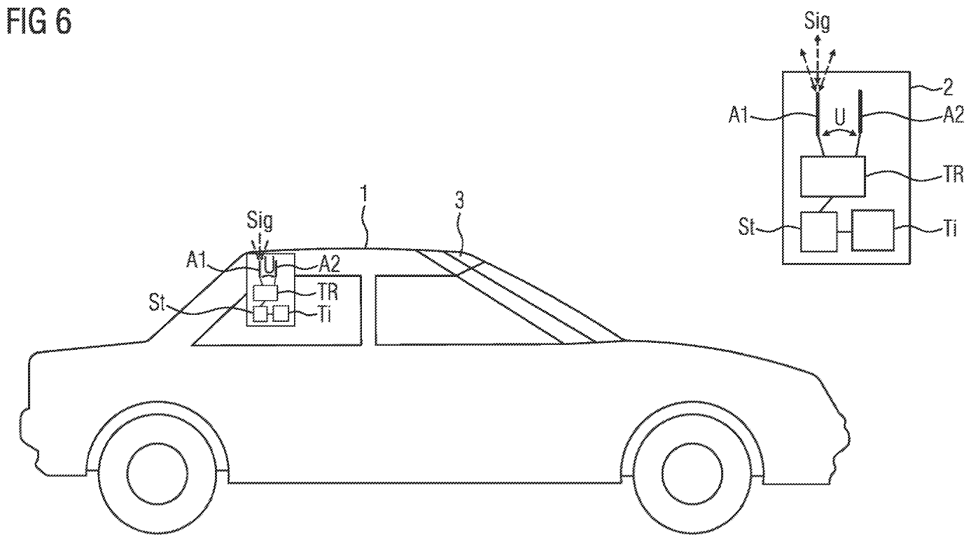

FIG. 6 shows a motor vehicle with a controller for controlling a transceiver for Bluetooth, in particular, for switching between at least two antennas depending on two counts and two limit values,

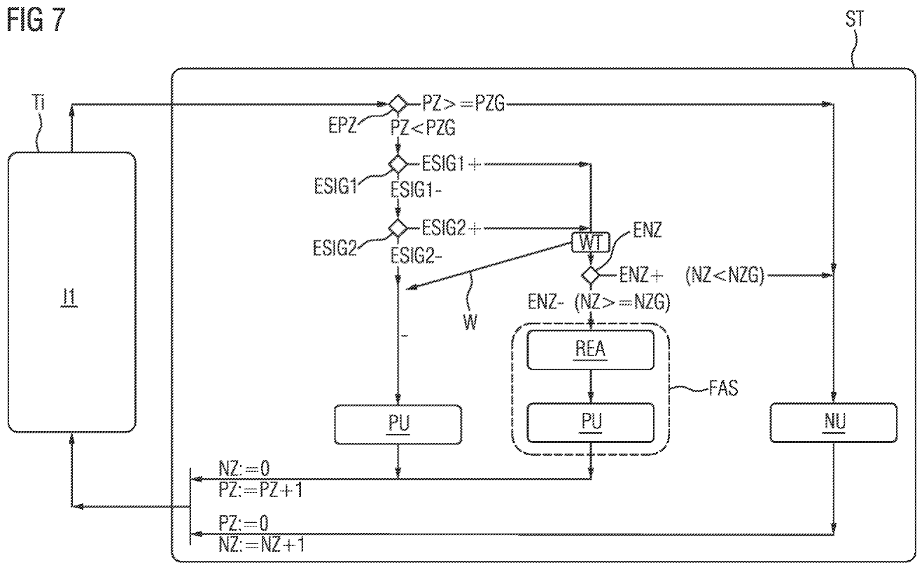

FIG. 7 shows a further flow diagram of an antenna switching decision, wherein a maximum waiting time for checking radio events is also provided,

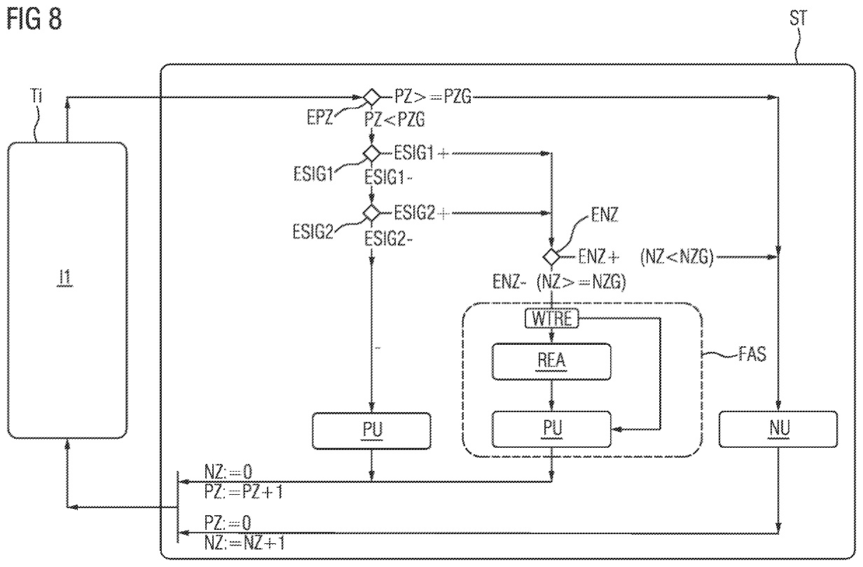

FIG. 8 shows a further flow diagram of an antenna switching decision, with a maximum waiting time until the end of a radio event is reached.

FIG. 6 shows a motor vehicle 1 and a mobile terminal 2 (e.g. cell phone, key, etc.) as examples of embodiments of the invention, in each case (1; 2) with a controller St for controlling a (more particularly Bluetooth) transceiver TR for switching U between two (or alternatively more than two) antennas A1, A2 depending on two counts (positive count PZ, ‘SwitchSuccess_Count’, and negative count NZ, ‘WaterLevel_Count’) and two limit values (positive count limit value (PZG, ‘SwitchSuccess_Threshold’) and negative count limit value (NZG, ‘WaterLevel_Threshold’)),
for avoiding antenna switchings U in the case of active and/or imminent radio (transmission/reception) events of the transmitting/receiving of signals Sig, and for forcing an antenna switching U in the case of a predefined number of successively negative (=no switching U) antenna switching decision events being reached (in each case at antenna switching decision instants T measured by way of a timer Ti), and for stopping an antenna switching U in the case of a predefined number of successively positive (=switching U) antenna switching decision events being reached (in each case at antenna switching decision instants T).
   Background to this:

For various reasons, present-day radio transmission techniques often operate in frequency bands above 1 GHz, for example in the 2.4 GHz—ISM—band of 2400 to 2480 MHz. Accordingly, wavelengths of a few centimeters are present (approximately 12.5 cm in the case of 2.4 GHz).

In buildings (office, underground parking garage), but also inside vehicles, the emitted signal is reflected in some instances multiple times e.g. at walls and ceilings. A signal consisting of the in-phase superposition of the different propagation paths according to their respective path loss and phase shift and also the antenna properties (polarization, directional characteristic) arises at the receiving antenna.

The in-phase superposition gives rise to constructive and destructive superpositions; the reception level is considerably influenced as a result. This is referred to as a multipath propagation situation, in which so-called fading occurs.

For different frequencies and antenna orientations, the multipath propagation situation present typically changes relatively quickly and statistically independent (uncorrelated) reception levels arise.

In contrast to the use of different frequencies (channels), a use of different antennas is rarely explicitly prescribed or provided in the transmission standards.

From a physical standpoint, however, the use of different antennas is just as expedient as the use of different frequencies. Furthermore, from the standpoint of the communication control (link layer) of the transmission standard, it makes no difference whether a signal transmission goes wrong on account of an “incorrect” frequency or on account of an “incorrect” antenna. An antenna switching therefore adapts relatively well to the communication sequence provided.

The present application discloses methods which enable an antenna switching U within the scope of the possibilities of a commercially available integrated circuit for BLE communication.

The link layer (LL) level of a transmission standard organizes the time-critical communication sequences of the data packets exchanged at the physical layer (PHY) level.

The communication sequences in the LL are often designed to be error-tolerant. Not every communication attempt must be successful; repeated attempts are directly provided. As a result, at times communication attempts may be made on antennas A1, A2 which might not actually be in range until later. This gives rise to an antenna diversity effect at the expense of the reaction time.

The application software defines the parameters of the link layer and issues superordinate commands with regard to the link layer operating states to be processed. The instants of the transmitting and receiving actions at the PHY level are not known to the application software.

The LL control is not straightforwardly accessible to the user of the IC. An implementation in a separate software part of the IC through to hardwiring is customary.

The LL control takes into consideration the HW conditions of the IC and has to behave in a manner conforming to the specification of a communication standard (for example Bluetooth 5.2), that is to say is usually certified.

Therefore, an antenna switching on the part of the user cannot be directly integrated in the link layer; it must be implemented at the application SW level.

One aspect of a method according to the invention is the realization of an antenna switching in application software of a transceiver IC. However, the method can also be directly integrated in an LL and would be comparatively simple and effective.

The following relates by way of example to a communication according to the Bluetooth Low Energy (BLE) communication standard.

The essential operating states of the BLE LL are “advertising”, “initiating/scanning” and “connected”.

Transmitting and receiving actions may need to be implemented periodically according to the respective state.

Modern ICs can implement the above-mentioned states quasi-simultaneously. By way of example, it is possible for an IC to establish up to eight connections to different remote stations and additionally also to carry out “advertising” and “initiating/scanning”. In this case, the link layer control of the IC can attend to the necessary time division multiplexing between the different state sequences or of the transmitting and receiving actions according to the given hardware resources of the IC.

An antenna switching U is intended to be integrated in these state sequences with the corresponding transmitting and receiving actions.

Over and above error-tolerant communication sequences in the LL for the use of different antennas, what matters here in particular is the implementation possibility that also enables different operating states to be processed quasi-simultaneously.

Theoretically, an antenna switching could be directly integrated in the LL. It would then be possible to actively control on which antenna the imminent transmitting or receiving actions are carried out and dependences of operating states or connections are taken into consideration. However, such a method would mean great management complexity.

In the case of an inaccessible LL, an antenna switching initiated by a timer Ti is conceivable. In this case, the antenna could be changed e.g. every 100 ms wholesale, i.e. independently of the operating state currently present.

Furthermore, it is conceivable for the antenna A1, A2 not to be changed in the case of a transmitting or receiving action that is just taking place or imminent.

Insofar as communication is not possible on an antenna A1, A2, a latency arises from the user's point of view. Furthermore, after a specific time in which communication was no longer possible, a BLE connection is deemed to be terminated (SuperVision TimeOut SVTO).

The behavior is problematic in the “initiating/scanning” operating state. In order to minimize the power consumption, scan events take place only infrequently, but they should take place on antennas that alternate with one another in order to minimize the reaction time.

Whereas a change of antenna takes place every 100 ms, for example, in order to avoid an SVTO on an “incorrect” antenna A1, A2 in a possible connection, a scanning event is carried out for 100 ms only every 1000 ms, for example.

Furthermore, it should be noted that, for a deterministic reaction time, it is often necessary to stay on the same antenna A1 or A2 etc. for the complete time of the scan window.

Insofar as the IC exclusively carries out “initiating/scanning”, an antenna switching U can be realized on the basis of messages to the application SW layer.

However, if a plurality of operating states have to be processed quasi-simultaneously (advertising or different connections in parallel), this solution becomes increasingly unusable on account of the number of messages to be taken into consideration.

The present patent application realizes these requirements in a simple manner.

Proceeding from an antenna switching based on a timer Ti, in accordance with embodiments of the invention the intention is to realize an antenna switching U which additionally takes into consideration the number of successive successful (to be switched in the form of a decision PU) and failed (not to be switched in the form of a decision NU) possible switching instants (i.e. in each case at an antenna switching decision instant T) (positive count PZ, ‘SwitchSuccess_Count’, and negative count NZ, ‘WaterLevel_Count’), as illustrated as a flow diagram in FIG. 1.

The antenna switching interval I1 is defined with the aid of a timer Ti. According to this periodicity, negative NU (i.e. not switching) and positive PU (i.e. switching) antenna switching decisions are in each case carried out periodically at antenna switching decision instants T (also referred to as antenna switching decision events).

At an antenna switching decision instant T, in each case (if the number of finally successive positive switching decisions PU lies below a limit value PZG) firstly a check is made (ESIG1, ESIG2) to ascertain whether a radio event RE (in the form of ongoing or planned transmitting and/or receiving of signals Sig), on the part of the link layer (=LL), is carried out (ESIG1+) or planned to occur soon (ESIG2+) or is not carried out (ESIG1−) and not planned to occur soon (ESIG2−).

If both are found not to be the case (ESIG1−) and ESIG2−), a positive switching decision PU can be effected and a switching U can be effected; otherwise (if the negative count NZ of previously successively negative switching decisions NU=‘WaterLevel_Count’ is less than a negative count limit value NZG ‘WaterLevel_Threshold’) a negative switching decision NU can be effected and no switching U can be effected.

Furthermore, a limited waiting time WT is conceivable which involves firstly attempting to wait (W) for the end of an active or imminent radio event phase RE.

Such a (optionally possible) waiting time WT is illustrated by way of example in the exemplary embodiment in FIG. 7. Insofar as a radio event RE is carried out or planned to occur soon (ESIG1+ and ESIG2+), the duration of waiting is for a maximum possible predefined waiting time WT. Insofar as the end of the radio event phase RE carried out or planned occurs (i.e. ESIG1− and ESIG2− occur) during this waiting time WT, a positive switching decision PU can be effected and a switching U can be effected. Insofar as radio events RE are carried out or planned to occur up to the end of the waiting time WT (ESIG1+ and ESIG2+ still hold true), the procedure continues with ENZ.

Insofar as the link layer (=LL) has to process many radio events RE, it can happen that relatively often no (positive switching decision PU and thus also no) antenna switching U is effected (NZ>NZG).

With the aid of the negative count NZ of previously successively negative switching decisions NU=‘WaterLevel_Count’, after a number (NZ>=NZG) of negative antenna switching decisions NZ corresponding to a negative count limit value NZG ‘WaterLevel_Threshold’ (=decision at antenna switching decision instants T that no switching U has to be effected), the active or imminent radio event RE (i.e. transmitting or receiving of signals Sig via an antenna A1 or A2) is terminated REA or prevented and an antenna switching U (from a first antenna A1 to a further antenna A2) is forced by a positive switching decision PU.

Before a possible radio event phase is actually terminated or prevented, a limited waiting time WTRE is additionally conceivable, as illustrated in FIG. 8. An attempt can thus be made to wait for the end of the radio event phase RE. Insofar as this succeeds, an active or imminent radio event RE does not have to be terminated or prevented. If radio events RE are active or imminent even after the waiting time WTRE has elapsed, they must be terminated or prevented as described above.

The reference sign FAS indicates a forced switching by way of termination REA of a transfer process and a positive decision PU for the switching U.

In the case of a forced switching FAS, the prevention of all active, imminent or possibly newly arising radio events RE should carry on at least until the conclusion of the antenna switching U in order that an undisturbed antenna switching U is ensured.

Prevention of e.g. unexpectedly (in the short term) newly imminent radio events is also conceivable for the duration of non-forced antenna switchings U and additionally ensures an undisturbed course of the antenna switching U.

After a positive switching decision PU for an antenna switching U (from a first antenna A1 to a further antenna A2), the
positive count PZ is increased by one (PZ:=PZ+1) and the
negative count NZ is set to zero (reset).

After a negative switching decision NU against an antenna switching U (from a first antenna A1 to a further antenna A2), the
negative count NZ is increased by one (NZ:=NZ+1) and the
positive count PZ is set to zero (reset).

The aim of this procedure is that in the typical case of e.g. only one active BLE (Bluetooth Low Energy) connection, an antenna switching U is virtually always effected and no or few radio events RE are damaged (i.e. terminated or prevented) (REA) by the antenna switching U. As the capacity of an IC is increasingly utilized, a switching U is forced; in this case, instances of radio event damage (terminations) REA are accepted, but a termination of BLE connections (via SVTO) if an antenna A1 or A2 is not in range is prevented and a minimum reaction time of the system and an antenna diversity effect are ensured.

With the aid of the positive count PZ, ‘SwitchSuccess_Count’, the number of successive successful antenna switching events, i.e. switchings U, is counted.

Upon a predefined positive count limit value PZG, ‘SwitchSuccess_Threshold’, being reached, an antenna switching U (for one or more following antenna switching events) is actively stopped (EPZ: PZ>PZG).

Furthermore, the antenna switching interval I1 is dimensioned according to the scan interval I2 between two scan windows SW (in each of which scanning takes place, e.g. for possible connections). Insofar as the scan interval I2 is equal to an even multiple of the antenna switching interval I1, relationships regarding the operating state “initiating/scanning” in accordance with FIG. 2 result for e.g. n=4, where FIG. 2 illustrates at the top the state RXSt (receiving RX in scan windows) of the transceiver TR and below that the receiving RE of signals by antennas A1 or A2:

In the above example, four antenna switching decision events (i.e. decisions for (PU) or against (NU) a switching U) take place per scan interval I2. Since a radio event RE that is active at the beginning thereof has the effect (in the case where NZ<NZG) that no antenna switching U is effected, directly successive scan events in scan windows SW are processed on different antennas A1, A2.

The phase of the antenna switching decision events need not be synchronized with those of the scan events. A special case arises for the zero phase, in which the beginning of a scan window SW coincides with the instant of an antenna switching event, as indicated by the arrow P1 on the left in FIG. 3.

However, since either toward the end or toward the beginning of a scan window SW, the antenna switching decision event lies minimally outside said window, an antenna switching U is effected at one of the two instants and, accordingly, successive scan events SW take place on different antennas A1, A2 during a zero phase (P2) as well.

Depending on the phase difference between scan timing and antenna switching timing, from time to time successive scan events SW are carried out on the same antenna A1 or A2. Within the scope of the achievable accuracies of the timers Ti, that is tolerable or limits the average tolerable error of the timer Ti for the antenna switching U.

The use of so-called SW timers might be problematic, these timers being allocated time slices for use of the CPU e.g. by a real-time operating (ROC) system. In this case, the timing for carrying out the scanning SW may have a higher priority than an additionally configured timer task for the antenna switching U.

This prioritization gives rise to synchronization effects, as a result of which an antenna switching is effected both at the beginning and at the end of a scan window SW in the vicinity of the zero phase P2, as shown in FIG. 4.

This gives rise to time periods in which in some instances considerably long scan events SW are carried out on only one antenna A1 or A2. Only the average error of the SW timer over ‘very’ long time periods (over ‘very’ many antenna switching instants) remains unaffected by such ROC effects.

In order to avoid such a behavior in the antenna switching U, a positive count PZ, ‘SwitchSuccess_Count’, of previously successively positive switching decisions PU is used to count the number of successive and (in the form of a positive switching decision, i.e. a switching U) successful antenna switching events. If this number exceeds a predefined positive count limit value (threshold value) PZG=‘SwitchSuccess_Threshold’, an antenna switching U is intentionally stopped (by way of a now negative switching decision NU, i.e. no switching).

In the present example, a failed antenna switching NU would be customary every four antenna switching events; it is forced by the positive count PZ, ‘SwitchSuccess_Count’, as shown by the arrow in FIG. 5:

As a result, successive scan intervals SW take place on different antennas A1 or A2 despite synchronization effects. Furthermore, the “Switch Success method” enables the time of the scan window to be chosen to be shorter than the antenna switching interval I1, which allows an additional degree of freedom in the system dimensioning.

### LIST OF REFERENCE SIGNS

1 Motor vehicle
2 Mobile terminal
ST Control
U Switching
A1 Antenna
A2 Antenna
Sig Signals
RE Radio event, transmitting or receiving of a signal Sig by antenna A1 or A2
REA Radio event terminated or prevented
TR Transceiver
Ti Timer
t Time
T Antenna switching decision instant
I1 Periodic antenna switching decision interval
I2 Scan interval in which the radio transceiver TR periodically scans
EPZ Decision/taking into consideration the positive count PZ
PZ=‘SwitchSuccess_Count’, positive count of previously successively positive switching decisions PU
PZG=‘SwitchSuccess_Threshold’, predefined positive count limit value
PZ>=PZG positive count PZ, ‘SwitchSuccess_Count’, at or above a predefined positive count limit value PZG, ‘SwitchSuccess_Threshold’
PU Positive switching decision
NU Negative switching decision NZ, ‘WaterLevel_Court’, negative count of previously successively negative switching decisions NU
NZG Negative count limit value (also ‘WaterLevel_Threshold’) of negative antenna switching decisions NU
ENZ Decision/taking into consideration the negative count (NZ, ‘WaterLevel_Count’) of previously successively negative switching decisions NU
PZ<PZG Positive count PZ, ‘SwitchSuccess_Count’, below a predefined positive count limit value PZG, ‘SwitchSuccess_Threshold’
ESIG1+ No transmitting or receiving of signals Sig carried out
ESIG2+ No transmitting or receiving of signals Sig planned within a predefined time
ESIG1− Transmitting or receiving of signals Sig carried out
ESIG2− Transmitting or receiving of signals Sig planned within a predefined time SW Scan window

1. A device for controlling antenna switching of a radio transceiver having two or more antennas configured to switch a transfer in a form of transmitting and/or receiving signals by a first antenna of the radio transceiver to a transfer of signals by a further antenna of the radio transceiver, wherein an antenna switching decision interval is defined, after which, a decision about the switching between the antennas is provided in each case at an antenna switching decision instant, taking into consideration a negative count of previously successively negative switching decisions.

2. The device as claimed in claim 1, wherein the decision about the switching between the antennas is provided in each case also taking into consideration positive count of previously successively positive switching decisions.

3. The device as claimed in claim 1, wherein the device is configured to provide a positive switching decision in a form of switching, a positive count lies below a predefined positive count limit value, and if, at an antenna switching decision instant, no transmitting or receiving of signals is carried out or is planned within a predefined time.

4. The device as claimed in claim 1, wherein the device is configured to provide a positive switching decision in a form of switching, if a positive count lies below a predefined positive count limit value, and if, at an antenna switching decision instant, transmitting or receiving of signals is carried out or is planned within a predefined time, and if the negative count is at or above a predefined negative count limit value.

5. The device as claimed in claim 1, wherein the device is configured to wait maximally for a predefined waiting time until transmitting or receiving of signals is no longer carried out or is no longer planned.

6. The device as claimed in claim 1, wherein the device is configured to provide a negative switching decision in a form of no switching, a positive count lies below a predefined positive count limit value, and if, at the antenna switching decision instant, transmitting or receiving of signals is carried out or is planned within a predefined time, and if the negative count is below a predefined negative count limit value.

7. The device as claimed in claim 1, wherein the device is configured to provide a negative switching decision in a form of no switching, if a positive count is at or above a predefined positive count limit value.

8. The device as claimed in claim 1, wherein the device is configured to provide an adaptation of at least the negative count, if a negative switching decision in a form of no switching is effected.

9. The device as claimed in claim 1, wherein the device is configured to the effect provide an adaptation of at least a positive count, if a positive switching decision in a form of a switching is effected.

10. The device as claimed in claim 1, wherein, if an adaptation of the negative count is provided, then an adaptation of a positive count is also provided, and/or if an adaptation of the positive count is provided, then an adaptation of the negative count is also provided.

11. The device as claimed in claim 1, wherein time duration of a scan interval in which the radio transceiver periodically scans is defined as an even multiple of time duration of antenna switching interval.

12. The device as claimed in claim 1, wherein the radio transceiver is a Bluetooth radio transceiver.

13. The device as claimed in claim 1, wherein the radio transceiver is part of a motor vehicle or mobile terminal.

14. A method for controlling antenna switching of a radio transceiver having at least two antennas, for switching transfer in a form of transmitting and/or receiving signals by a first antenna of the radio transceiver toward a transfer of signals by a further antenna of the radio transceiver,
wherein a decision about the switching between the antennas is effected in each case at an antenna switching decision instant, taking into consideration a negative count of previously successively negative switching decisions.

15. The method as claimed in claim 14, wherein a decision about the switching between the antennas is effected taking into consideration also a positive count of previously successively positive switching decisions.

16. The device as claimed in claim 4, wherein the positive switching decision in the form of switching includes termination or prevention of the transfer.

17. The device as claimed in claim 11, wherein a Bluetooth radio transceiver scans in operating state “initiating/scanning”.

18. The device as claimed in claim 1, wherein the radio transceiver is a Bluetooth Low Energy radio transceiver.
